(19) United States
(12) Patent Application Publication
(10) Pub. No.: US 2006/0031288 A1
(43) Pub. Date: Feb. 9, 2006

(54) Method of and system for presenting media content to a user or group of users

(75) Inventors: Herman Jan Ter Horst, Eindhoven (NL); Markus Gerardus Leonardus Maria Van Doorn, Eindhoven (NL); Natasha Kravtsova, Eindhoven (NL); Warner Rudolph Theophile Ten Kate, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/531,800

(22) PCT Filed: Sep. 22, 2003
(86) PCT No.: PCT/IB03/04199

§ 371 Date: Apr. 18, 2005

(30) Foreign Application Priority Data
Oct. 21, 2002 (EP) 02079382.4

(51) Int. Cl. G06F 15/16

(52) U.S. Cl. 709/204

(57) ABSTRACT

The invention relates to a method of presenting media content to a user or group of users, wherein the media content resides on a storage system and the method comprises the steps of defining a query to retrieve the media content, which query is appropriate for the user's situation by using context information; retrieve the queried media content from the storage system; and presenting the queried media content to the user or group of users.

The invention relates to a method of presenting media content to a user or group of users, wherein the media content resides on a storage system.

The invention further relates to a system for presenting media content to a user or group of users, wherein the media content resides on a storage system.

The invention further relates to a computer program product designed to perform such a method.

The invention further relates to an information carrier comprising such a computer program product.

The invention further relates to an entertainment device comprising such a system.

An embodiment of such a method and system is described in U.S. Pat. No. 6,311,194. Here, a system and method for creating a database of metadata of a variety of digital media content, including TV and radio content delivered on the Internet is described. The method captures and enhances domain or subject specific metadata of digital media content, including the specific meaning and intended use of original media content. To support semantics, a WorldModel is provided that includes specific domain knowledge, ontologies as well as a set of rules relevant to the original content. One of the languages that is used to express the domain knowledge is the Extensible Markup Language (XML), as defined by the World Wide Web Consortium (W3C), see http://www.w3.org The database of metadata may also be dynamic in that it may track changes to the media content, including live and archival TV and radio programming. The database of metadata can be queried by a user. Hereto, a user must specify the domain of interest of the WorldModel and then the user is presented with a form that contains fields for each of the attributes that belong to that domain. The user must fill in this form and submit the form to execute the query. An other way of submitting a query can be performed by letting the user choose a domain and enter keywords. A third way of submitting a query is established by supplying a user interface that is customized to a single domain. The user can then select the user interface of the domain that the user whishes to query. All these queries require explicit user interaction.

It is an object of the invention to provide a method according to the preamble that retrieves media content in an improved way. To achieve this object, the method comprises defining a query to retrieve the media content, which query is appropriate for the user's situation by using context information; retrieve the queried media content from the storage system; and presenting the queried media content to the user or group of users. By combining sensor data about a user's situation with context information, high level user situations can be derived. For example, it can be derived that the user is at home and relaxing when it is detected that the user is home alone and sits in his or hers favorite armchair. Derivation of the context information can be performed automatically without explicit user interaction.

WO 01/69380 describes the use of context information in order to create a user interface to enable a user to retrieve content from a database. The context information comprises descriptive information about the abilities of a user. The descriptive information is supplied to the system explicitly by the user. The context information can further comprise the operating context conditions of the user, like situational, environmental, behavioral and the location of the user like at home or in a car. The context information is used together with the descriptive information to compute preferences for the specific user and create a user interface that is operable by the user. For example, when a user cannot use his or her extremities, it can be determined that control and entry functions are not to be operated using hands, but that voice is preferred for these modes of interaction. Therefore, only the presentation and operation of access controls are influenced by the context information. However, the content that the user wants to retrieve is not effected by this context information.

An embodiment of the method according to the invention is described in claim 2. Within this embodiment, the context information comprises at least one of sensor data about at least one person present, sensor data about at least one object present, a context-dependent user profile, a context-dependent group profile. In this way, for example a person can be recognized, the individual persons of a group or just the number of people can be counted, in order to determine the user's situation automatically. Furthermore, objects that are present within the environment can be taken into account. For example, when there are a lot of persons present and the room is decorated with balloons, it can be derived that a party is going on and that party music should be retrieved from the internet. As an other example, the music preferences of a number of people within a group can be used to retrieve music from the internet that all these people like. The context information can also take a group of persons into account in stead of only the individuals.

An embodiment of the method according to the invention is described in claim 3. Within this embodiment, the context information comprises a combination of events of which each event is described by means of at least one of information about space, information about time, and information about who or what is described by the respective event. Moreover, it can be useful to record metadata about events, including, for example, who or what stated the event. Space can describe both physical space and virtual space, like the world wide web (a set of Uniform Resource Identifiers, URIs). This general way of using events enables reasoning about context information, and may simplify expressions of and reasoning with context knowledge. Furthermore all kinds of user situations can be expressed by events. For example, an object can be regarded as an event; a time interval can be regarded as an event; a person can be regarded as an event, perhaps regarded throughout his or her entire lifetime, or only for a day; and the presence of a person in a certain place during a certain hour can be regarded as an event.

An embodiment of the method according to the invention is described in &aim 4. Within this embodiment, the context information contains a mathematical relation between the events to enable reasoning about the events. This enables to express that an event is C composed of other events; that two events intersect, etc. In particular, such mathematical relations between events allow conclusions such as that a certain event can be concluded to apply to a certain context, when certain other events are known to apply to the context. In this way, the high-level user situations already mentioned can be derived from low-level sensor data about context of use. This derivation process may take several steps.

An embodiment of the method according to the invention is described in claim 5. Within this embodiment, events comprise at least one of a physical event, a content event, a people event, and an input event. The physical, people and input events describe context. By distinguishing between different kinds of events further reasoning about events is enabled.

An embodiment of the method according to the invention is described in claim 6. Within this embodiment, the user profile and the group profile are based upon at least one profile rule, and the at least one profile rule describes, for the user or group of users, an action concerning which possible event should be realized according to the user or group of users when a given event takes place, and the method comprises the step of applying the at least one profile rule to the context information which includes the given event, in order to determine the possible event. An action can for example be the action “do”. This action can require the realization of the possible event when the given event occurs. In a typical application, the given event in a profile rule describes context, and the possible event describes content. But a profile rule can also be used to express other likes or dislikes or instructions, such as: given a certain song, another song is also very interesting; when the telephone rings, turn the sound level down; when I am alone and concentrated, please do not disturb. By using a conjunction to include two users in the given event of a rule, a profile for a specific pair of users can be built.

An embodiment of the method according to the invention is described in claim 7. Within this embodiment, the possible event is determined using a rating value and the user who gave the rating value. An example of an action that can appear in the profile rule, is the action to rate the possible event for the situation that the given event occurs. By including both the rating value and the user who gave the rating value, the importance of the rule can be determined. In some cases, for example, it can be desirable to give high priority to the ratings determined by the person who hosts a group of people.

An embodiment of the method according to the invention is described in claim 8. Within this embodiment, a Semantic Web language is used to represent information about the media content and the context information. The term “Semantic Web” stands for a vision on the future of the World Wide Web, see Berners-Lee, T. 1998. Semantic Web Road Map. World Wide Web Consortium, http://www.w3.org/DesignIssues/Semantic.html; Berners-Lee, T., with Fischetti, M., 1999. Weaving the web. Harper Collins, N.Y.; and Berners-Lee, T., Hendler, J., and Lassila, O. 2001. The Semantic Web. Scientific American, May 2001, http://www.scientificamerican.com/2001/0501issue/0501berners-lee.html. The Semantic Web languages can be used to facilitate representation of and reasoning with information on the internet. For this purpose, the Resource Description Framework, see http://www.w3.org/TR/REC-rdf-sntax (RDF) and RDF Schema, see http://www.w3.org/TR/2000/CR-rdf-schema-20000327 and the Web Ontology Language, see http://www.w3.org/2001/sw/WebOnt/ (OWL) can be used.

An embodiment of the method according to the invention is described in claim 9. Within this embodiment, the user profiles of different users are separately stored on different places on the internet. By storing the user profiles on different places on the internet, storage capacity requirements are distributed over a number of servers connected to the internet. Furthermore, the user profiles can be accessed from different places and there's no need for several copies of a user profile stored at different servers. By having their preference file available on the internet, possibly protected for private use only, users can benefit from that profile in a plurality of situations. For example, when arriving at a hotel somewhere in the world, the room's radio can play music using the knowledge offered through those preferences. (This assumes that the hotel's radio is part of an internet radio system.) Maintenance of the user profiles can also be simplified, since a user can update the preference file and consistency problems are addressed within the context of that preference file. Further, by using the internet, it is possible to update the preferences at any time from any place.

An embodiment of the method according to the invention is described in claim 10. Within this embodiment the known mathematical relations between events are located on a central server. This information plays a central role in the process to determine queries that are suitable for particular user situations. Locating this information on a central server, facilitates the possibility to exercise control over this information, in particular to maintain (update) this information. Moreover, it leads to advantages with respect to performance, reliability and security. In addition, there is only one connection needed to this server to retrieve all of this information. In the use of the mathematical relations from the server, transformations may be made to other forms of representation that differ from the way in which these relations were originally stored.

An embodiment of the method according to the invention is described in claim 11. Within this embodiment, the method comprises the step of applying a query creation strategy. By applying different query creation strategies, different media content can be retrieved from the internet based upon the same context information. Examples of such a query creation strategy are: everybody equal, dedicated to particular user, host strategy, or a majority strategy.

An embodiment of the method according to the invention is described in claim 12. Within this embodiment, the method comprises the step of retrieving the queried media content by means of collaborative filtering. By using collaborative filtering, a well known technique can be used that has proven to be effective. It allows media content to be retrieved by means of queries that are formulated in a rather general way, for example in terms of keywords describing music genres, rather than identifiers of specific songs.

It is a further object of the invention to provide a system according to the preamble that enables retrieval of media content in an improved way. To achieve this object, the system comprises: defining means conceived to define a query to retrieve the media content, the query being appropriate for the user's situation by using context information; retrieving means conceived to retrieve the queried media content from the storage system; and presenting means conceived to present the queried media content to the user.

It is a further object of the invention to provide a computer program product according to the preamble that enables retrieval of media content in an improved way. To achieve this object, the computer program product is designed to perform the method according to the invention.

It is a further object of the invention to provide an information carrier according to the preamble that enables retrieval of media content in an improved way. To achieve this object, the information carrier comprises the computer program product according to the invention.

It is a further object of the invention to provide an entertainment device according to the preamble that enables retrieval of media content in an improved way. To achieve this object, the entertainment device comprises the system according to the invention.

These and other aspects of the invention will be apparent from and elucidated with reference to the embodiments described hereinafter as illustrated by the following Figures:

FIG. 1 illustrates a global system architecture of a media-related system;

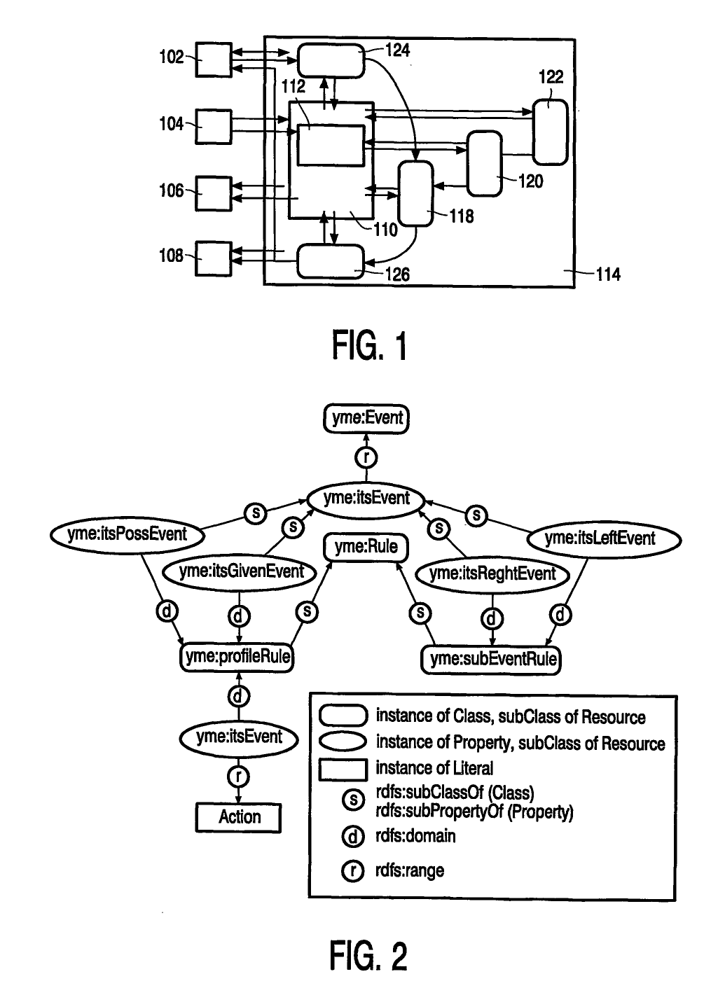

FIG. 2 illustrates a model of RDF data,

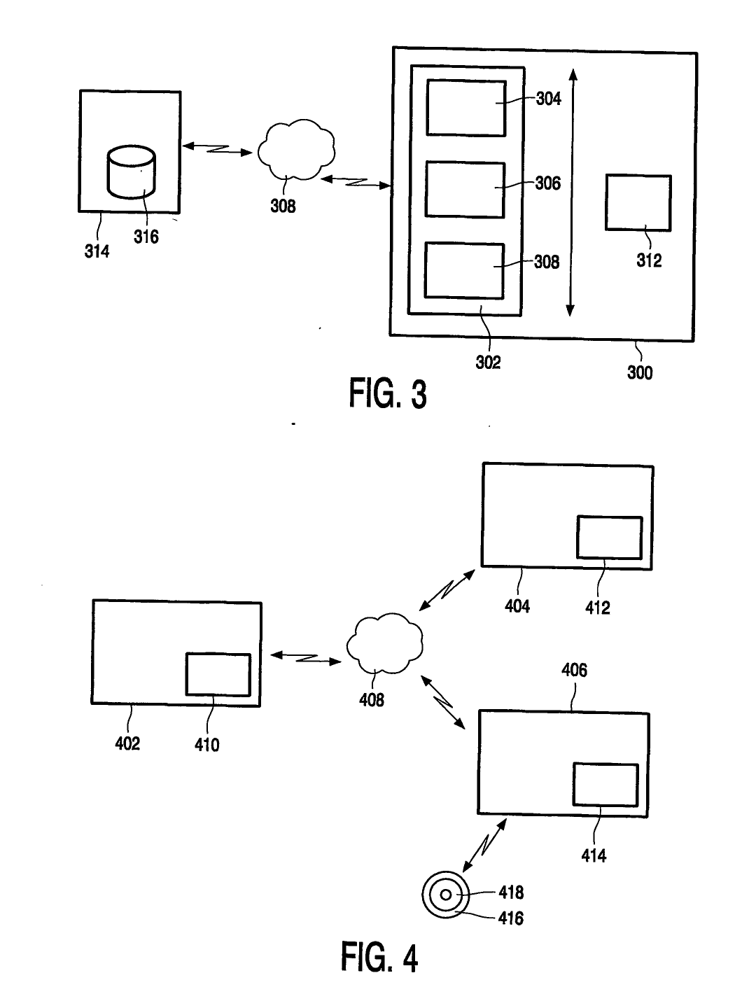

FIG. 3 illustrates the main parts of a system according to the invention in a schematic way;

FIG. 4 illustrates internet-enabled devices comprising the system according to the invention in a schematic way.

The term ‘Semantic Web’ stands for an increasingly popular vision on the future of the World Wide Web, see Berners-Lee, T. 1998. Semantic Web Road Map. World Wide Web Consortium, http://www.w3.org/DesignIssues/Semantic.html, Berners-Lee, T., with Fischetti, M., 1999. Weaving the Web. Harper Collins, New York or Berners-Lee, T., Hendler, J., and Lassila, O. 2001. The Semantic Web. Scientific American, May 2001. Available electronically at http://www.scientificamerican.com/2001/0501issue/0501berners-lee.html. There is a serious effort toward the realization of the Semantic Web. The World Wide Web Consortium (W3C) organizes the development of languages to support the Semantic Web.

Since its inception, the existing Web allows people to view and retrieve data residing anywhere on the Web. The Semantic Web is intended to be a Web of data that can be processed by machines.

The existing Web can be viewed as a large ‘book’, where data can primarily be found via links to specific pages, or by looking for the occurrence of specific words on pages. The Semantic Web is envisaged as a large ‘database’ or ‘knowledge base’. With an ordinary database, data can be found by specifying a request in terms of the meaning of what is desired. The Semantic Web is intended to record information in a machine understandable way, where understanding means understanding meaning, or relating to things already understood, just as for people.

Whereas the existing Web can be viewed as the combination of Internet and hypertext, the Semantic Web is viewed as the combination of Internet and knowledge representation: in the field of knowledge representation it is investigated how knowledge can be represented in such a way that reasoning with knowledge can be automated. The Semantic Web might be described by the slogan make reasoning explicit. In the current situation, reasoning processes often remain largely hidden, within Java programs, for example. The knowledge required by reasoning processes can be made explicit using XML, without the use of Semantic Web technology. XML does offer general means to specify grammars that can be used to specify the order of items in documents, but currently does not offer general means to specify the meaning of certain kinds of information. A central point of the Semantic Web vision is to arrive at uniform mechanisms for representing knowledge and meaning on the Web. Facts and rules for drawing conclusions are to be explicitly represented on the Semantic Web, in such a way that any computer program can follow the actual reasoning.

The Semantic Web is intended to increase the possibility to develop intelligent agents exploiting the Web. When data is expressed with semantics, in a standardized way, the vision is that it could even be handled by a computer program that was not specially developed to deal with this specific data.

While the existing Web makes use of HTML and XML, the Semantic Web exploits, in addition, a so-called ontology language for specifying meaning of information. The standard Semantic Web languages will be based on XML, and will be accompanied by standard implementations that can automatically incorporate basic inference steps implied by information on the Semantic Web. Thereby, the Semantic Web languages and their implementations facilitate the development of Web-based systems with reasoning functionality. The first steps in this direction have been made with the (XML-based) languages RDF and RDF Schema.

FIG. 1 illustrates a global system architecture of a media-related system. The system presents media (music, video, games, etc.) in a way that adapts to the current context. As an example, the preferences of people present can be used to determine suitable songs to be played. In addition to adaptation, direct user input is also allowed. Internet and Web technology can be applied to realize this kind of adaptivity. In particular, Semantic Web technology can be used to facilitate representation of and reasoning with information on the Internet, and an automated query formulation procedure is developed to connect to information retrieval systems. The invention can make existing recommender systems context-aware, and applicable to groups of people instead of only individual persons. The invention uses context information, which includes information about people and objects present, rules for reasoning about the context, and context-dependent user profiles.

This section describes a global architecture for the development of media-related systems that know about the context of use and that can adapt to this context. This architecture is depicted in FIG. 1.

Interaction with the users, and observations about the context of use, take place by means of various I/O devices, 102 to 108. For example, there can be input devices, output devices, sensors, and actuators. The input and output devices represent the tools for interaction between human and system, and include such devices as remote controls and displays. Media content can be provided to users by means of output devices. The sensors represent the devices that the system uses to detect or infer the current situation of the user, such that it can adapt the user-system interaction in a context-aware manner. Of course, the system can also use the information received through the input devices. Examples of sensors are given by tag readers that sense (the ID of) the objects in a room, or by equipment for automatic vision.

The scope of the invention is not solely restricted to the presentation of media content in forms such as audio, video, or graphics. The concepts of the invention can also be applied to take care of selection or adjustment of other conditions, like lighting or room temperature, in a way that diminishes the need for explicit user input. In this case, the I/O devices previously mentioned include actuators controlling lighting or heating equipment, for example. In particular, it can for example be natural to accompany media presentations with suitable adjustments of lighting conditions.

A central part of the system architecture is formed by an information store, which allows to describe, link and distribute information about users, devices, content items and experiences on a global scale, in a machine understandable way. The phrase ‘ambient information’ is used to refer to the information about content and context required by context-aware, adaptive media systems. Making this ambient information 112 explicit on the Semantic Web 110, allows us to customize the computing processes 116 to 124 involved in adaptation of content on the Web 114 for different user experiences involving different I/O devices 102 to 108. The I/O devices 102 to 108 communicate with these computing processes 116 to 124 either directly by exchanging XML or indirectly by writing XML (RDF) to the Semantic Web. It should be noted that in this description of the global system architecture, the Semantic Web is just one way of organizing storing of ambient information. As an alternative to the Semantic Web, the ordinary Web could be used, or a centralized way of storing information, by means of database technology, for example. Analogously, content could be taken from a centralized content store, rather than from the Web.

The realization of ambient information 112 as part of the Semantic Web 110 is done by distributing and linking RDF documents. Real objects (e.g. persons, devices, physical objects) and virtual objects (e.g. content items, web services, general knowledge rules) can be associated with RDF documents that describe these objects in a machine understandable way. Relations between objects can be described by linking these RDF documents.

The architecture of FIG. 1 consists of a maintenance component and an operative component. The maintenance component consists of crawling 122 and indexing processes 120. The operative component in FIG. 1 consists of query formulation 124, information retrieval 118 and presentation generation processes 126.

The first step is handled by the query formulation process 124. Its task is to analyze the input received from the different input devices 102 to 108 either directly or indirectly through the Semantic Web 110. Based on this information and the context information that can be already present on the Semantic Web 110 it then calculates a query and determines to which retrieval process 118 it should forward this query.

The second step involves the execution of this query against one or more retrieval processed 118 hosted by one or more different content providers. The task of the retrieval process 118 is to compare this query against the document representations created by the indexing process 120 and return the best matching document representations from a database according to some underlying similarity function. The retrieval process 118 determines which document representations should be presented. The retrieval process 118 may be executed by different retrieval engines that are located at different servers.

The third step, the presentation generation process 126, generates documents for the output devices 102 to 108 that surround the user. Its first task is to analyze the output received by the retrieval process 118 and determine how these document representations can be structured into new documents that can be presented to the user by the output devices 102 to 108. Based on this information and context information already present on the Semantic Web 110 (e.g. knowledge about the device capabilities, the target application, and the user) it then generates the documents and delivers the right document to the right output device (or stores the document in the Semantic Web 110 for later use). The presentation generation process 126 determines in the end what the output devices 102 to 108 should interpret, e.g. present on screen. How this is actually done is left to the output device 102 to 108 itself.

The ambient information component 112, comprises the required information about context and content. Management of ambient information can involve database aspects as well as AI aspects. The database aspects deal, for example, with data definitions, distribution over files, transaction management, concurrency, and security. The AI aspects involve knowledge representation and reasoning, for example: what kind of concepts should be used to describe context, what sort of rules should be used to reason about context?

In several approaches to the problem to represent knowledge about context, there is a separation between static and dynamic aspects. For example, situation calculus, an approach that has been widely investigated in AI, distinguishes situations, at distinct points in time, between which transitions occur (see, e.g., McCarthy, J. 1963. Situations, actions and causal laws. Technical Report, Stanford University, 1963. Reprinted in Semantic Information Processing (M. Minsky ed.), MIT Press, Cambridge, Mass., 1968, pp. 410-417 or Russell, S. J., and Norvig, P. 1995. Artificial Intelligence. Prentice Hall, Englewood Cliffs). As another example, temporal logic separates a layer of statements describing the validity in time of certain other statements (see, e.g., Allen, J. F. 1983. Maintaining Knowledge about Temporal Intervals. Commun. ACM 26(11) pp. 832-843 or Allen, J. F. 1984. Towards a general theory of action and time. Artificial Intelligence 23(2) pp. 123-154). Such approaches tend to become complicated, for example when dealing with simultaneous events with different durations. Therefore, it has advantages to integrate spatial and temporal aspects (see Hayes, P. J., 1985. Naïve physics I: Ontology for liquids. In Hobbs, J. R. and Moore, R. C. (editors), Formal Theories of the Commonsense World, pp. 71-107. Ablex, Norwood; see also the book by Russell and Norvig just cited). It seems that simplified information modeling can be obtained when static and dynamic aspects are not separated from each other from the beginning. Therefore, the invention considers an approach which views spatial and temporal aspects in an integrated way, and takes the notion of event as central.

Quite generally, an important tradeoff in the area of knowledge representation deals with the question of expressive power versus reasoning efficiency. A high expressive power may lead to intractibility of reasoning, while efficient reasoning may only be obtainable in combination with limited expressivity. This has been an argument in favor of specialized knowledge representation schemes, combined with dedicated reasoning procedures and algorithms.

Here, the context information mainly considers the following aspects:
context: situation, events, people present etc.
knowledge about context, determining the way in which one can reason about context,
people and their preferences regarding content, in a context-dependent way.

Furthermore the context can be considered as a combination of events. The word event should be interpreted in a very general way. Each event is associated to a chunk (that is, a subset) of space-time, where space includes not only the ordinary physical space but also virtual dimensions. It is sometimes convenient to simply identify an event with a chunk of space-time. For example, an object is viewed as an event (spreading out over time), and a time interval is also viewed as an event (spreading out over space). A person can also be regarded as an event, perhaps regarded throughout his or her entire lifetime, or only for a day. The presence of a person in a certain place during a certain hour can also be regarded as an event.

This general way of looking at events may simplify expressions of and reasoning with context knowledge. It can lead, for example, to an unification of static objects and dynamic changes.

One of the relationships between events is the subevent relationship, which specifies that a certain event is part of another event. In this case, the (space-time chunk of the) first event is a subset of the (space-time chunk of the) second event. So events may be composed of other events.

One can form the conjunction of two events, whose space-time chunk is the union of the space-time chunks of the two events. Conjunction of events is denoted by the infix operator A, or by the keyword AND. The most general event is any-event, which occupies the complete space-time. The most specific event is empty-event, which occupies the empty subset of space-time, and therefore does not represent a realistic event.

The real physical space can be extended with virtual dimensions. In particular, the set of URLs (URIs) describing items on the World Wide Web is thought to be part of space.

For the purpose of dealing with context-aware media systems the following kinds of events can be distinguished:
Physical events do not involve people, but deal for example with configuration of devices, including lighting, curtains, and phones. This includes triggers, such as the ringing of the telephone.
Content events may describe the existence of content items, and also the fact that certain content is being presented in a certain time interval at a certain place, for example with a certain sound level. Hence a content event may involve ordinary space as well as a URI.
People events involve people, of course. For example, people entering or leaving a room, expressions of emotion, etc.
Input events are expressions of certain people that are intended as input for the environment (that is, the system). Examples: an explicit request, feedback to certain music, an action with the effect to rate a certain piece of music. So the class of input events can be viewed as part of the class of people events.

Physical events, people events, or input events can be referred to as context events.

Certain high-level user situations can be referred to as a special kind of people events. Several examples of such user situations can be given as follows: Alone:relaxing, Alone:concentrated, Party:big (festive), Party:small (conversation), Mobile, Car, Romantic, Waking up, Going to sleep, Nobody present.

Knowledge about context is described in terms of what will be called atomic events. Events that are not expressed as a conjunction of events, are required to be atomic events. For each atomic event, at least one of the following three attributes should be included in an event description: position, or region of space; time or time interval; name of event, or, more specifically, who or what is stated by this event. For complex space-time chunks, a more complicated description of space and time aspects may be required. In addition, it can be relevant to include metadata about events, for example who or what stated the event, at what time. It should be noted that incomplete information is allowed. As an example, the starting time of an event (the birthdate of a person, for instance) might be unknown. Furthermore other attributes can be included in an event description without departing from the concept of the invention.

An important issue involves the detection of user situations. Instead of telling the system that a group of people who were sitting and talking, suddenly started to dance when a famous song started to play, this can be automatically concluded from the readings of certain pressure sensors. The ‘level of ambient intelligence’ can be higher when there are more high-level user situations that can be automatically deduced from low-level, automatic observations.

Reasoning about events can be done using mathematical relations between events, which can be expressed using subevent rules. Subevent rules express that a certain event is part of another event:
(SUBEVENT eventA, eventB) (1)

This rule specifies that the space-time chunk of eventA is a subset of the space-time chunk of eventB. In this syntactic description of a subevent rule, eventA is called the left-hand side and eventB is called the right-hand side of the rule. The left-hand side of a subevent rule can be a conjunction of a finite number of atomic events, while the right-hand side of a subevent rule should be an atomic event. This requirement on the left-hand side and the right-hand side of a subevent rule determines the possible extents of the mathematical relation specified by a set of subevent rules. The basic reasoning step involving subevent rules is a form of modus ponens, described as follows.
eventA AND (SUBEVENT eventA, eventB) imply eventB. (2)

A subevent rule can be stated to hold when, if each atomic event in its left-hand side applies to a certain context, the atomic event in its right-hand side can also be concluded to apply to the context. Hence subevent rules allow the possibility to state sufficient conditions for the deduction of user situations. The main purpose is to be able to draw conclusions about high-level user situations when given low-level sensor data about context of use. As an example, a subevent rule might conclude from the events ‘there is only one person present’ and ‘sitting in armchair’ that the event (user situation) ‘alone relaxing’ holds. For another person, the conclusion from the same two events might be ‘alone concentrated’ instead. The use of subevent rules makes such choices flexible and customizable, and can be put under the control of users.

In order to describe user profiles, profile rules of the following form are included:
(PROFILE user, givenEvent, possibleEvent, action). (3)

Note that other notations can be used too for subevent rules and profile rules without departing from the concept of the invention.

The first attribute in such a profile rule indicates the user for which the rule is expressed. The next two attributes describe a given event and a possible event, respectively. The given event can be a conjunction of a finite number of atomic events, while the possible event should be an atomic event. The last attribute describes an action concerning the possible event of the rule that should be realized, in the view of the user, when the given event of the rule actually takes place. An example of an action is do: this action requires the realization of the possible event when the given event occurs. When the actuators include devices controlling lamps, for example, profile rules might be used that include actions to adjust lighting conditions when certain conditions are satisfied. Another example of an action that can appear in a profile rule is the action to rate the possible event for the situation that the given event occurs. Values of such ratings can be expressed on a five-point scale, for example: then, a rating can be denoted by rating[i], where i is between 1 and 5.

In a typical application, the given event in a profile rule describes context, and the possible event describes content. But a user may also use profile rules to express other likes or dislikes or instructions, such as: given a certain song, another song is also very interesting; when the telephone rings, turn the sound level down; when I am alone and concentrated, please do not disturb. By using a conjunction to include two users in the given event of a rule, one can build up a profile for a specific pair of users. As was already mentioned, possible events in profile rules should be atomic events. More particularly, we can require possible events in profile rules to be stereotypes, which are identified with music genres.

The query formulation process 124 can be described as follows:
although users are also enabled to express desires to the system, the query formulation component is intended to contribute by being able to automatically formulate queries on the basis of context information. The query formulation component delivers information about desired content and possibly also about the current context. The query formulation component combines the relevant individual user profiles and applies these to the current context, using a certain kind of reasoning about the context, to find a suitable description of desired content. The query formulation output can be a list of weighted, ‘stereotype’ user profiles. On the basis of the input from the query formulation component, the retrieval system delivers a list of content identifiers (a list of content URLs and possibly associated annotation).

The query formulation process 124 comprises the following steps:

First, a context determination step applies the subevent rules to the event descriptions recording the events detected by the sensors to find the complete set of atomic events describing the current context. Such a resulting set of events is called a context description. The context determination step can be viewed as performing an interpretation of the input observations of the sensors. For example, the context determination step typically translates certain low-level observations into high-level user situations. Note that in general the context determination step may involve ‘chaining’ of rules. That is, a subevent rule may be applicable to an event that was obtained by applying another subevent rule.

The context determination step uses most of the computation required for the query formulation procedure. In order to show that its computational complexity is low-degree polynomial, an algorithm for the context determination step is given. The algorithm uses two variables, distinguished by a capital: Context and Rule. The value of the variable Context is taken to be a set of atomic events.
Context := set of input events
repeat until Context remains unchanged
   for each subevent rule Rule do
      if left-hand side of Rule is contained in Context
      then add right-hand side of Rule to Context
return Context.

Let e be the total number of atomic events appearing in the input and in the subevent rules, let s be the number of subevent rules, and let k be the maximum number of atomic events that appear in a subevent rule. Then, it follows that the time complexity of this algorithm for the context determination step is O(e²sk).

Second, a preference determination step applies the profile rules to a context description to determine a set of possible events combined with rating values and the persons who gave these ratings, and to determine the events that should be realized in the view of the persons involved. If a user has two profile rules such that the given event is included in the context description, and if the given event of the first rule is more specific than the given event of the second rule, then only the first rule is selected in the preference determination step. Here, an event is taken to be more specific than another event if it is a conjunction including all atomic events of the second event, and if it also includes additional atomic events.

Denoting the set of users present in the current context by U_{c}, the set of stereotypes by S, and the set of actions that can be assigned to stereotypes in profile rules by A, the preference determination step essentially determines a mathematical function
φᵤ:Sᵤ→A
for each user u∈Uᵤ, where Sᵤ⊂S is the set of stereotypes selected in the profile rules for user u in the preference determination step.

The output of this preference determination step is used in the query creation step, which generates the actual query that is sent to the retrieval component. The query creation step determines a weight p, for each stereotype s∈S, in such a way that 0≦pₛ≦1 and

$${\sum }_{s ∈ S} {p}_{s} = 1.$$

Several possibilities for the query creation step can be considered. In order to describe these, some terminology needs to be introduced. Each user u∈U_{c} is given a user priority fᵤ in such a way that 0≦fᵤ≦1 and

$${\sum }_{u ∈ U} {f}_{u} = 1.$$

Moreover, each action a∈A is assigned a number w(a)≧0 called an action weight.

As an example, the following actions can be considered as previously described:
A={do, rating [i]:1≦i≦5}. (4)

These actions can be given the following weights, for example:
w(do)=5, w(5)=3, w(4)=2, w(i)=0(i≦3). (5)

Given the user priorities fᵤ, the functions φᵤ, and the actions weights w(a) as just defined, the weight of a stereotype s∈S can be defined to be

$${p}_{s} = {\sum }_{u ∈ {U}_{c} : s ∈ {S}_{u}} {f}_{u} \frac{w ( {φ}_{u} ( s ) )}{{\sum }_{{s}^{′} ∈ {S}_{u}} w ( {φ}_{u} ( {s}^{′} ) )} . \qquad ( 6 )$$

In words, the outer sum is taken over all users in the current context for which the stereotype s is selected in the preference determination step. In this definition, the denominators are introduced to diminish the influence of each individual profile rule assertion for a user for whom many stereotypes appear in the profile rules for the current context. It can be proved that this definition satisfies

$${\sum }_{s ∈ S} {p}_{s} = 1.$$

Many query creation strategies can be defined by by using formula (6) in combination with specific values of the user priorities fᵤ. For example, the everybody equal strategy (E) gives each user equal priority:

$${f}_{u} = \frac{1}{\vert {U}_{c} \vert} ( u ∈ {U}_{c} ) .$$

Another strategy, dedicated to particular user (D), gives a specific user d∈U the highest priority f_{d}, while the other users each get the same, lower priority:

$${f}_{u} = \frac{1 - {f}_{d}}{\vert {U}_{c} \vert - 1} ( u ∈ {U}_{c} , u \neq d ) .$$

An example of this strategy is the host strategy (H), dedicated to the host of a meeting or party, for example.

Each of the strategies E, D, H can be supplemented with another step, called make least happy more happy (L): the idea is that if a person does not like a stereotype, then this stereotype is not included in the query formulation output. This can be realized as follows:
if φᵤ(s)=1 or 2 for some user u∈U_{c}, then put pₛ=0. Subsequently, the weights pₛ need to be renormalized so that

$${\sum }_{s ∈ S} {p}_{s} = 1.$$

It should be noted that, in principle, it is possible that each of the weights pₛ would become 0 in this way, in which case this step cannot be applied.

As an alternative to the strategies just discussed, there is a majority strategy (M), which is not defined in terms of Equation 6, but which simply returns the stereotypes that appear most often with the top action do:

$$arg {max}_{s ∈ S} \vert \{ u ∈ {U}_{c} : {φ}_{u0} ( s ) = do \} \vert ,$$

and gives these stereotypes equal weight (usually, this will lead to just one stereotype).

The query creation step can use either one of the strategies E, D, or H (possibly supplemented with L), or the strategy M. It is natural to give control over the choice of the query creation strategy to a host user. It should be noted that alternative query creation strategies can be defined without departing from the concept of the invention.

Now the functionality of the information retrieval process 118 is further described. With the current invention existing recommender systems can be made context-aware, and applicable to groups of people instead of only individual persons. Hereto, collaborative filtering (see, e.g., Goldberg, D., Nichols, D., Oki, B. M., and Terry, D. 1992. Using Collaborative Filtering to Weave an Information Tapestry. Comm. ACM. 32(12) pp. 51-60, or Breese, J., Heckerman, D., and Kadie, C. 1998. Empirical Analysis of Predictive Algorithms for Collaborative Filtering. In Proceedings of the 14th Conference on Uncertainty in Artificial Intelligence, Madison, Wis.), can be used.

A standard procedure for collaborative filtering can be described as follows:

The central data is a user database, containing votes vu I from users u on items i. In the typical application area considered in this invention, items are media content items. If the application is music selection, then items can be songs. The set of all users is denoted by U and the set of all items by I. Although the algorithm is more general, it is assumed that the votes are taken from a five-point scale, with values from 1 to 5. If Iᵤ is the set of items on which user u has voted, then the mean vote for user u is:

$${\overline{v}}_{n} = \frac{1}{\vert {I}_{u} \vert} {\sum }_{i ∈ {I}_{u}} {v}_{u , i} .$$

If w(u,u′) is defined as the user similarity between user u and user u′ and Uᵤ as the set of users with nonzero user similarity scores (relative to user u) then the predicted vote P_{u,i} of user u for item i is described as follows:

$${p}_{u , i} = {\overline{v}}_{u} + {k}_{u} {\sum }_{{u}^{′} ∈ {U}_{u}} w ( u , {u}^{′} ) ( {v}_{{u}^{′} , i} - {\overline{v}}_{{u}^{′}} ) , \qquad ( 7 )$$

where kᵤ is a normalization constant defined by means of the equation

$${k}_{u} {\sum }_{{u}^{′} ∈ {U}_{u}} w ( u , {u}^{′} ) = 1.$$

For the user similarity w(u,u′) there are several definitions in use. Hereto, the vector similarity definition can be used:

$$w ( u , {u}^{′} ) = {\sum }_{i ∈ {I}_{u} ⋂ {I}_{{u}^{′}}} \frac{{v}_{u , i}}{\sqrt{{\sum }_{i ∈ {I}_{u}} {v}_{u , i}^{2}}} \frac{{v}_{{u}^{′} , i}}{\sqrt{{\sum }_{i ∈ {I}_{{u}^{′}}} {v}_{{u}^{′} , i}^{2}}} . \qquad ( 8 )$$

Here the squared terms in the denominator serve to normalize votes so that users that vote on more titles will not a priori be more similar to other users. Note that vector similarity in collaborative filtering is an adaptation of vector similarity in information retrieval. Users take the role of documents, titles take the role of words, and votes take the role of word frequencies.

For a user u, the output of the collaborative filtering process is a list of items i, ordered by means of the values of p_{u,i}. Note that this process delivers recommendations for an individual user, whose votes are assumed to be present in the user database.

In order to apply this procedure to groups of users, whose votes do possibly not appear in the user database, in a context-dependent way, the votes from a new user can be added to the user database. The disadvantage of this approach is that it can lead to scalability problems because the user similarity matrix w (u, u′) must be recalculated at run-time. Another problem is that the votes v_{u,i} are context-independent: for example, they do not make clear that a certain user may want classical music in one situation, and popular music in another situation.

In order to solve these problems, it is allowed to define a group profile, in a dynamical way, as a weighted linear combination of existing user profiles, and determine the prediction of the group by taking a weighted average of the individual user predictions. If G is a group of users and w_{u,G} is the weight of user profile u in this group, than the group prediction p_{G,i} for an item i can be defined as follows:

$${p}_{G , i} = {\sum }_{u ∈ G} {w}_{u , G} \cdot {p}_{u , i} . \qquad ( 9 )$$

Here the weights w_{u,G} are required to satisfy

$${\sum }_{u ∈ G} {w}_{u , G} = 1.$$

Instead of assuming that the individual data of the users in the current context are in the user database used by the collaborative filtering procedure, a set S of stereotypes can be taken. Stereotypes are viewed as ‘users’ in the collaborative filtering database, which are identified with content genres, and which can be defined in terms of votes on particular content items. Examples of such stereotypes could be: LatinMusic, Rock, ClassicalMusic, Sinatra, Waking-up, Romantic.

The query formulation procedure, as previously discussed, delivers a set of nonnegative weights pₛ of stereotypes s∈S such that

$${\sum }_{s ∈ S} {p}_{s} = 1.$$

These weights are used to find recommendations based on collaborative filtering, in the way previously described, with the set of stereotypes S taking the place of the group of users G in formula (9). Now, the votes of a user who is present in the current context do not have to be in the user database used by the collaborative filtering procedure. Therefore, the profile rules used to determine user profiles in a context-dependent way can be completely independent from the collaborative-filtering database v_{u,i}. There is no need for frequent updates of the user similarity matrix.

An embodiment of the invention is an application scenario, together with an indication of the context information that can be used to realize this scenario. This example uses all the technology discussed above: the general notion of events (in particular, user situations), subevent rules, and profile rules; context determination, preference determination, and query creation; retrieval based on collaborative filtering by means of stereotypes. This scenario illustrates another feature of the invention, namely that a context does not need to refer to one place, but can refer to distinct, disconnected places where people reside who want to share the same media content. For example a person sitting in a car wants to share songs with a person sitting at home. Current media systems based on the internet, such as the internet radio, enable such sharing of tailored media content between places that are remote from each other. The invention can also be applied in such situations. A source of complexity in the example is formed by the user profiles and the context knowledge, which can reside in different files on the Semantic Web. How this is done is illustrated in the following section.

The scenario reads as follows

Tom is in the room, listening to classical music.
Ann, Kate, Bob enter the room.
Music changes according to the profiles of all users.
Somebody brings (puts on the table) a palm tree, which is associated with a special kind of party, a Latin party.
Music changes again. The party continues.
Mike calls and says that he is stuck in the traffic jam and will be 30 minutes later.
Tom offers him to listen to the music, which is now playing at the party. Mike says: “that's a very good idea”.
Music starts playing in the car . . .
The party is finished.
Everybody is gone, everything is switched off.

The following subevent rules form the context knowledge that can be used to realize the scenario:
(SUBEVENT userA, person)
(SUBEVENT userB, person)
(SUBEVENT userC, person)
(SUBEVENT userD, person)
(SUBEVENT userE, person)
(SUBEVENT #persons=1 AND sittingInAmchair, userSituationAR)
(SUBEVENT #persons>=3, userSituationSP)
(SUBEVENT #persons=0, userSituationNP)
function: #persons( )

Here a function #persons is introduced to count the number of persons present. Moreover, AR stands for ‘alone:relaxing’, SP for ‘small party’, and NP for ‘nobody present’. As an example, here are a few of the profile rules:
(PROFILE userA, userSituationAR, ClassicalMusic, do)
(PROFILE userA, userSituationSP, PartyMusic, do)
(PROFILE userA, userSituationNP, NoMusic, do)
(PROFILE userB, userSituationSP AND PalmTreePutOnTable, LatinMusic, do)
(PROFILE userB, userSituationAR, songX, rating[5])

Below, the scenario is replayed and the events detected by sensors as well as the events derived by the system are summarized.

In the initial phase, when Tom is alone, the following events have been detected by the input sensors:
userA, sittingInArmchair,
   and the following event is derived by the system:
userSituationAR.

In this situation, the system selects classical music. When Ann, Kate and Bob entered, the sensors detect the following events:
userA, userB, userC, userD,
   and the system derives the following event:
userSituationSP.

In this situation, party music is selected by the system. After the palm tree has been put on the table, the sensors detect the following events:
userA, userB, userC, userD, PalmTreePutOnTable
   and the following event is derived:
userSituationSP.

In this situation, the system selects Latin music. After Mike called, the only change is the addition of one user to the context file, in such a way that the room is thought to be extended with Mike's car.

At the end of the scenario, everybody is gone, there are no events in the context file, the system deduces the following event:
userSituationNP,
   and no music is played.

FIG. 2 illustrates a model of RDF data describing the context information previously discussed. Several basic RDF Schema properties are denoted by an arrow through a circle, which encloses a letter. This holds for the properties rdfs:subClassOf and rdfs:subPropertyof (for both, the letter s is used), as well as the properties rdfs:domain (letter: d) and rdfs:range (letter: r). Class names are enclosed in rounded rectangles, property names in ovals, and names of literals in rectangles.

The main classes are yme:Event and yme:Rule. The class yme:Rule has two subclasses: yme:subEventRule and yme:profileRule. The central property is yme:itsEvent, with subproperties yme:itsGivenEvent, yrne:itsPossEvent, yme:itsLeftEvent, and yme:itsRightEvent. The range of the property yme:itsEvent is the class yme:Event. The domain of both properties yme:itsGivenEvent and yme:itsPossEvent is the class yme:profileRule. The domain of both properties yme:itsLeftEvent and yme:itsRightEvent is the class yme:subEventRule. Finally, there is the property yme:itsAction, with domain yme:profileRule and range Action (a Literal type).

For simplicity, FIG. 2 does not include the resources rdf:Property, rdfs:Class and rdfs:Resource, and the various rdf type statements used to indicate that each property is a property and each class is a class.

When the Semantic Web language RDF is used, the following kinds of RDF files can be included:
a context file describing the context as determined by input sensors as a combination of events,
a context knowledge file, containing subevent rules describing general knowledge for reasoning about the context,
a profile file for each user, containing profile rules.

If a user is present in a certain context, then the context file contains a link to the profile for this user. Explicit user input is dealt with using input events added to the context file.

The following examples illustrate the way in which subevent rules and profile rules are described in RDF. The subevent rule (SUBEVENT eventA AND eventB, eventC) can be described in the following way:

<rdf:Description rdf:about=“http:// . . . /yme/coKn.rdf#subEventRuleA”>

<rdf:type rdf:resource=“http:// . . . /yme/yme#subEventRule”/>
<yme:itsLeftEvent rdf:resource=“http:// . . . yme/coKn.rdf#eventA”/>
<yme:itsLeftEvent rdf:resource=“http:// . . . /yme/coKn.rdf#
eventB”/>
<yme:itsRightEvent rdf:resource=“http:// . . . /yme/coKn.rdf#
eventC”/>

</rdf:Description>

The various URLs are abbreviated for notational purposes. The profile rule (PROFILE userA, eventA, eventB, actionA) can be described in the following way:

<rdf:Description rdf:about=“http:// . . . /usPr-userA.rdf#profileRuleA”>

<rdf:type rdf:resource=“http:// . . . /yme/yme#profileRule”/>
<yme:itsGivenEvent rdf:resource=“http:// . . . /yme/coKn.rdf#
eventA”/>
<yme:itsPossEvent rdf:resource=“http:// . . . /yme/coKn.rdf#
eventB”/>
<rdf:itsAction>actionA<rdf:itsAction>

</rdf:Description>

In addition, the events that appear in these rules can be declared to be events, in the following way:

<rdf:Description rdf:about=“http:// . . . /yme/coKn.rdf#eventA”>

<rdf:type rdf:resource=“http:// . . . /yme/yme#Event”/>

</rdf:Description>

These examples show that subevent rules and profile rules are also represented in RDF/XML in the form of a kind of rules. These RDF statements are accompanied by RDF Schema information that is used for interpretation. The schema for the RDF data just illustrated is illustrated in FIG. 2.

The query formulation process can be implemented as follows: the initial reasoning steps (context determination and preference determination) can be made available via a special API, which is used to realize the query creation step in combination with the appropriate types of RDF files. The API can be realized in Java, for example, using a Java class library for manipulating RDF and RDF Schema information, as for example The Jena Semantic Web Toolkit, developed by Hewlett-Packard., see http://www.hpl.hp.com/semweb/jena-top.htmlJena.

Several advantages of the current invention can be summarized as follows. First, existing media recommenders can be made context-aware without having to rewrite them from scratch. Second, by using standard Internet and Web technology interoperability and convenience to the user can be enabled. Both the Internet radio at the party and the radio in Mike's car (see the scenario previously discussed) can access the same playlist simply by selecting the same URL. Third, by making user profiles available on the Web, the same user profile can be accessed in other context-aware media systems.

FIG. 3 illustrates the main parts of a system according to the invention in a schematic way. The system 300 comprises a random access memory 302, a software bus 310, and a central processing unit 312. The memory 302 can communicate with the central processing unit 312 via software bus 310. The memory 302 comprises computer readable code 304, 306, and 308. The computer readable code 304 is designed to perform the query formulation process as previously described. The computer readable code 306 is designed to perform the information retrieval process as previously described and the computer readable code 308 is designed to perform the presentation generation process as previously described. The information retrieval process is designed to retrieve media content that is stored upon a remotely located storage system 314. The storage system 314 and the system according to the invention are connected to each other through the internet. The storage system 314 can be a server that comprises a database 316 comprising for example audio and video files. The storage system 314 can also be distributed over a number of servers and each server comprises a number of audio and/or video files. The system is described by means of example as a software system. However, dedicated hardware or combinations of software with hardware, like programmable hardware that is designed to perform the mentioned method steps is included too.

FIG. 4 illustrates internet-enabled devices comprising the system according to the invention in a schematic way. An internet-enabled television set 402 comprises the system according to the invention 410 and is bilaterally connected via an internet connection 408 to an internet-enabled radio 404. The internet-enabled radio comprises 404 a system according to the invention 412 and is bilaterally connected via the internet connection 408 to a personal computer 406. The personal computer 406 comprises a system according to the invention 414 and is bilaterally connected to the television set 402. The personal computer 406 can download the computer readable code 418 that is designed to perform the method according to the invention as previously described. The computer readable code 418 can be read by the personal computer 406 from a storage device 416, like a CD, CD+RW, DVD, etc. The television set 402, radio 404, and personal computer 406 are examples of internet-enabled devices. Other devices that are internet-enabled are also feasible like for example a mobile phone.

The order in the described embodiments of the method of the current invention is not mandatory, a person skilled in the art may change the order of steps or perform steps concurrently using threading models, multi-processor systems or multiple processes without departing from the concept as intended by the current invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of presenting media content to a user or group of users, wherein the media content resides on a storage system and the method comprises the steps of:
defining a query to retrieve the media content, which query is appropriate for the user's situation by using context information;
retrieve the queried media content from the storage system; and
presenting the queried media content to the user or group of users.

2. Method of presenting media content to a user or group of users according to claim 1, wherein the context information comprises at least one of sensor data about at least one person present, sensor data about at least one object present, a context-dependent user profile, and a context-dependent group profile.

3. Method of presenting media content to a user or group of users according to claim 1, wherein the context information comprises a combination of events of which each event is described by means of at least one of information about space, information about time, and information about who or what is described by the respective event.

4. Method of presenting media content to a user or group of users according to claim 3, wherein the context information contains a mathematical relation between the events to enable reasoning about the events.

5. Method of presenting media content to a user or group of users according to claim 3, wherein events comprise at least one of a physical event, a content event, a people event, and an input event.

6. Method of presenting media content to a user or group of users according to claim 2, wherein the user profile and the group profile are based upon at least one profile rule, and the at least one profile rule describes, for the user or group of users, an action concerning a possible event which possible event should be realized according to the user or group of users when a given event takes place and, the method comprising the step of applying the at least one profile rule to the context information which includes the given event, in order to determine the possible event.

7. Method of presenting media content to a user or group of users according to claim 6, wherein the possible event is determined using a rating value and the user who gave the rating value.

8. Method of presenting media content to a user or group of users according to claim 2, wherein a Semantic Web language is used to represent information about the media content and the context information.

9. Method of presenting media content to a user or group of users according to claim 2, wherein the user profiles of different users are separately stored on different places on the internet.

10. Method of presenting media content to a user or group of users according to claim 6, wherein the mathematical relations for reasoning about events are located on a central server.

11. Method of presenting media content to a user or group of users according to claim 6, the method comprising the step of applying a query creation strategy to determine the at least one profile rule to apply.

12. Method of presenting media content to a user according to claim 1, the method comprising the step of retrieving the queried media content by means of collaborative filtering.

13. System for presenting media content to a user, wherein the media content resides on a storage system and the system comprises:
defining means conceived to define a query to retrieve the media content, the query being appropriate for the user's situation by using context information;
retrieving means conceived to retrieve the queried media content from the storage system; and
presenting means conceived to present the queried media content to the user.

14. Computer program product designed to perform the method according to claim 1.

15. Information carrier comprising the computer program product according to claim 14.

16. Entertainment device comprising the system according to claim 13.
